(19) United States
(12) Patent Application Publication
(10) Pub. No.: US 2019/0178301 A1
(43) Pub. Date: Jun. 13, 2019

(54) TORQUE LIMITER

(71) Applicant: Peter WITTE, Kiel (DE)

(72) Inventor: Peter WITTE, Kiel (DE)

(21) Appl. No.: 16/278,683

(22) Filed: Feb. 18, 2019

Related U.S. Application Data
(63) Continuation-in-part of application No. PCT/DE2017/100669, filed on Aug. 8, 2017.

(30) Foreign Application Priority Data
Aug. 19, 2016 (DE) 20 2016 104 553.3

(51) Int. Cl. F16D 7/10; F16D 43/208

(52) U.S. Cl. CPC F16D 7/10; B25B 23/1427; F16D 43/208

(57) ABSTRACT

A torque limiter for a surgical screwdriver that includes an outer sleeve (1); a snap sleeve (3), which is arranged in and rotates with the outer sleeve; a rolling element cage (6), which is arranged in the snap sleeve; an inner sleeve (10), which is arranged in the rolling element cage; and a force-transmitting shaft (11), which is received in and rotates with the inner sleeve. The inner wall of the outer sleeve is provided with recesses (8) that extend parallel to a rotational axis of the force-transmitting shaft. The rolling element cage is provided with a plurality of rolling element receiving areas (5), each of which holds a rolling element (4), and with a number of noses (7), which engage into the recesses. The inner sleeve is provided with a plurality of notches (9), which extend in a V-shape parallel to the axis and which receive the rolling elements.

### CROSS-REFERENCE TO RELATED APPLICATIONS

This application is a continuation-in-part of International Application No. PCT/DE2017/100669, filed Aug. 8, 2017, and claims priority to German Patent Application No. 20 2016 104 553.3, filed Aug. 19, 2016.

### BACKGROUND OF INVENTION

### Field of Invention

The invention relates to a torque limiter, in particular a torque limiter for limiting the torque of a surgical screwdriver.

### Brief Description of Related Art

A torque limiter for a surgical screwdriver is disclosed in DE 20 2006 004 027. In this torque limiter, a problem arises in that the elasticity of the elastic element configured as an elastomer O-ring significantly varies and changes over time, in particular as a result of thermal stress.

An object of the invention is to provide a torque limiter in which the maximum torque which is able to be transmitted may be determined with a greater degree of accuracy and does not change significantly, even as a result of thermal stress on the torque limiter—namely during the sterilization thereof.

According to the invention, this object is achieved by a torque limiter as disclosed and claimed herein.

### BRIEF SUMMARY OF THE INVENTION

According to the invention, a torque limiter is provided, in particular for a surgical screwdriver, comprising an outer sleeve, a snap sleeve which is rotationally fixed in the outer sleeve; a rolling element cage which is arranged in the snap sleeve, an inner sleeve which is arranged in the rolling element cage and a force-transmitting shaft which is received by the inner sleeve in a rotationally fixed manner, wherein the inner wall of the outer sleeve is provided with recesses extending parallel to the axis, the rolling element cage is provided with a plurality of rolling element receiving areas, each of which holds a rolling element, and with a number of noses which engage into the recesses and the width of which is less than the open width of the recesses, said number corresponding to the number of recesses, and the inner sleeve is provided with a plurality of V-shaped notches which extend parallel to the axis and which are used to receive the rolling elements such that a torque applied to the outer sleeve in the screwing direction presses one side of the noses against one of the walls of the recesses into a position in which the rolling elements that are slightly offset relative to the noses are flush with the recesses, thus allowing the rolling elements to exit the V-shaped notches of the inner sleeve into the recesses of the outer sleeve while spreading the snap sleeve when a maximally permissible torque is reached, thereby uncoupling the inner sleeve, and a torque applied to the outer sleeve in the unscrewing direction presses the other side of the noses against the other wall of the recesses into a position in which the rolling elements are flush with the webs remaining between the recesses, thus preventing the rolling elements from exiting the V-shaped notches of the inner sleeve, thereby coupling the inner sleeve.

By means of this coupling, a positive connection is made between the outer sleeve and the inner sleeve. By means of this mechanism, an unlimited transmission of force is ensured in the unscrewing direction. In this position, the snap sleeve is uncoupled from any actions of force. As a result, a long functional life of the torque limiter as a whole, a consistent accuracy and thus the reproducibility of the actuating torques are ensured.

Preferably, the rotational fixing between the outer sleeve and the snap sleeve is effected by the provision of a drive element on the inner wall of the outer sleeve, said drive element protruding radially inwardly and engaging in the slot in the snap sleeve.

Further preferably, the rolling elements are configured as pins and the rolling element receiving areas are configured as slots.

According to an even further preferred embodiment, specifically the shaft is provided at its tip with a cone supported in a bearing cap.

Finally, it is advantageous if the snap sleeve is produced from a polyetheretherketone (PEEK).

The foregoing and other features of the invention are hereinafter more fully described below, the following description setting forth in detail certain illustrative embodiments of the invention, these being indicative, however, of but a few of the various ways in which the principles of the present invention may be employed.

### BRIEF DESCRIPTION OF THE DRAWINGS

The invention is described hereinafter with reference to a drawing, in which:

FIG. 1 shows an outer view of an exemplary embodiment of a torque limiter according to the invention;

FIG. 2 shows a longitudinal sectional view of the torque limiter along the line A-A of FIG. 1;

FIG. 3 shows a longitudinal sectional view of the torque limiter corresponding to FIG. 2, showing the inner sleeve;

FIG. 4 shows a sectional view along the line D-D of FIG. 3;

FIG. 5 shows a sectional view along the line C-C of FIG. 3; and

FIG. 6 shows a longitudinal sectional view corresponding to FIG. 3, showing the rolling element cage.

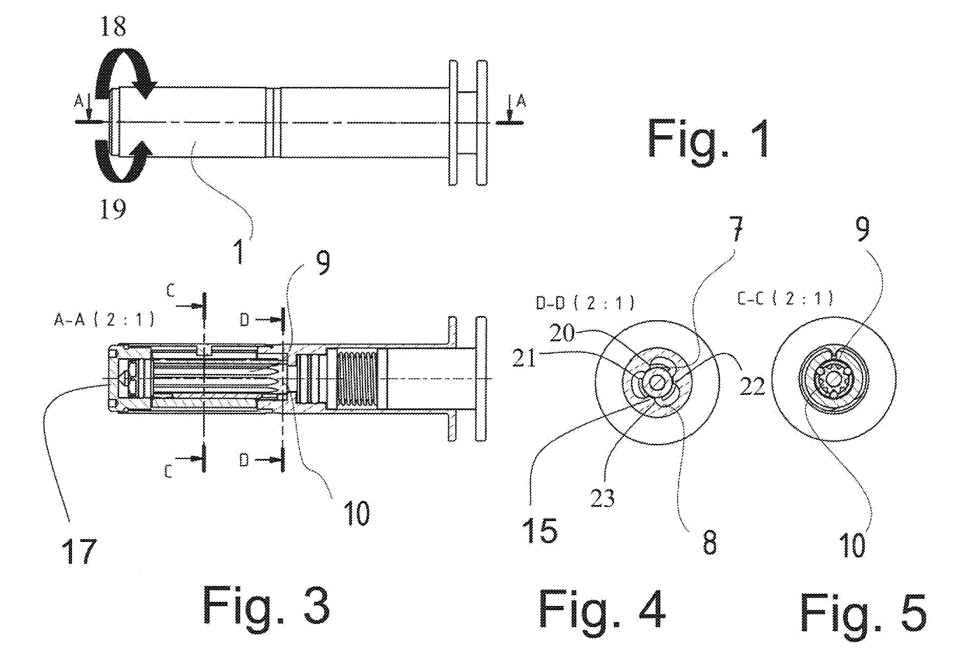

### DETAILED DESCRIPTION OF THE INVENTION

The figures show torque limiter, in particular for a surgical screwdriver, comprising an outer sleeve 1, a snap sleeve 3 which is rotationally fixed in the outer sleeve; a rolling element cage 6 which is arranged in the snap sleeve, an inner sleeve 10 which is arranged in the rolling element cage and a force-transmitting shaft 11 which is received by the inner sleeve in a rotationally fixed /manner.

The inner wall of the outer sleeve 1 is provided with recesses 8 extending parallel to the axis of rotation of the force-transmitting shaft. The rolling element cage 6 is provided with a plurality of rolling element receiving areas 5, each of which holds a rolling element 4, and with a number of noses 7 which engage into the recesses 8 and the width of which is less than the open width of the recesses 8, said number corresponding to the number of recesses 8, and which are slightly offset relative to the rolling element receiving areas 5. The inner sleeve 10 has a plurality of notches 9 which extend in a V-shape parallel to the axis and which are used to receive the rolling elements 4.

A torque applied to the outer sleeve 1 in the screwing direction 18 presses one side 20 of the noses 7 against one of the walls 22 of the recesses 8 into a position in which the rolling elements 4 are flush with the recesses 8, thus allowing the rolling elements 4 to exit the V-shaped notches 9 of the inner sleeve 10 into the recesses 8 of the outer sleeve 1 while spreading the snap sleeve 3 when a maximally permissible torque is reached, thereby uncoupling the inner sleeve 10.

A torque applied to the outer sleeve 1 in the unscrewing direction 19 presses the other side 21 of the noses 7 against the other wall 23 of the recesses 8 into a position in which the rolling elements 4 are flush with the webs 15 remaining between the recesses 8, thus preventing the rolling elements 4 from exiting the V-shaped notches 9 of the inner sleeve 10, thereby coupling the inner sleeve 10.

In the exemplary embodiment shown, the rotational fixing between the outer sleeve 1 and the snap sleeve 3 is effected by the provision of a drive element 2 on the inner wall of the outer sleeve 1, said drive element protruding radially inwardly and engaging in the slot 24 in the snap sleeve 3.

In this case, the rolling elements 4 are configured as pins and the rolling element receiving areas 5 are configured as slots.

The shaft 11, which when used for a surgical instrument receives the instrument at its end 25 protruding the outer sleeve 1, is provided at its other end with a cone 12 mounted in a bearing cap 17. In this case, the tip of the cone 12 is oriented counter to the bearing cap and in practical use comes into contact therewith.

When using the torque limiter, a virtually friction-free mounting between the outer sleeve 1 and the inner sleeve 10 is achieved by means of the cone 12 mounted in the bearing cap. This structural feature minimizes the friction torques and enables a greater accuracy and thus reduced scattering of the adjusted torque.

Polyetheretherketone PEEK lends itself as the material for the snap sleeve 3, this plastics material being able to be easily sterilized whilst maintaining its elasticity.

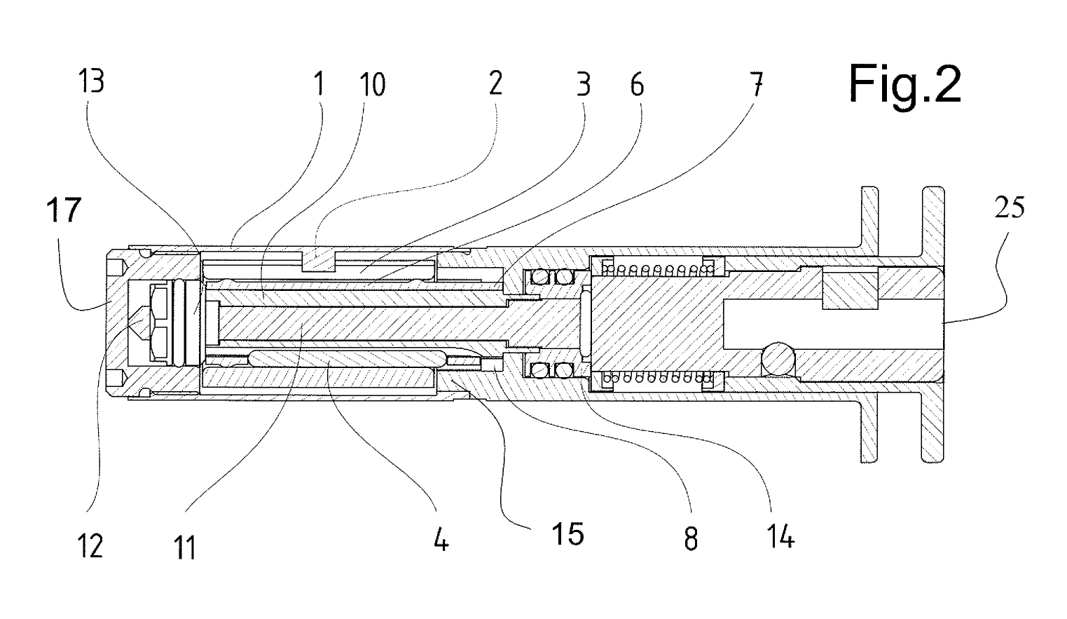

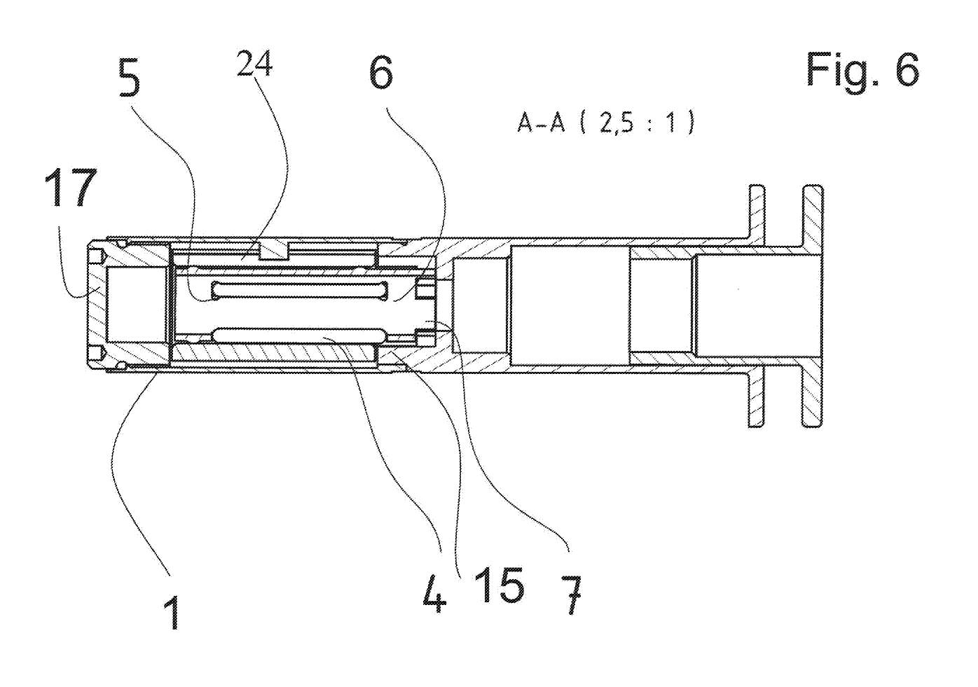

A sealing nut 13 is positioned nearby the cone 12. A sealing disc 14 is also shown in FIG. 2. The sealing nut 13 and the sealing cone 12 are sealing the torque limiter against the surrounding, i.e. water vapor and seal or arrange the bearings of the shaft 11.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. A torque limiter for a surgical screwdriver comprising:
an outer sleeve;
a snap sleeve which is arranged in the outer sleeve and which is fixed to rotate with the outer sleeve;
a rolling element cage which is arranged in the snap sleeve;
an inner sleeve which is arranged in the rolling element cage; and
a force-transmitting shaft which is received within the inner sleeve and which is fixed to rotate with the inner sleeve;
wherein an inner wall of the outer sleeve is provided with recesses that extend parallel to an axis of rotation of the force-transmitting shaft,
wherein the rolling element cage is provided with a plurality of rolling element receiving areas, each of which holds a rolling element,
wherein the rolling element cage is also provided with a number of noses, said number corresponding to the number of recesses,
wherein the noses are configured to engage into the recesses provided in the inner wall of the outer sleeve,
wherein the noses have a width that is less than an open width of the recesses, wherein the inner sleeve is provided with a plurality of V-shaped notches which extend parallel to the axis and which receive the rolling elements such that:
when a maximally permissible torque is applied to the outer sleeve in a screwing direction, sides of the noses are pressed against sides of walls the recesses thereby moving the inner sleeve into a position in which the rolling elements that are slightly offset relative to the noses are flush with the recesses allowing the rolling elements to exit the V-shaped notches of the inner sleeve into the recesses of the outer sleeve while spreading apart the snap sleeve and thereby uncoupling the inner sleeve from the outer sleeve, and
when a torque is applied to the outer sleeve in an unscrewing direction, opposite sides of the noses are pressed against opposite sides of the walls of the recesses thereby moving the inner sleeve into a position in which the rolling elements are flush with webs remaining between the recesses, thus preventing the rolling elements from exiting the V-shaped notches of the inner sleeve and thereby coupling the inner sleeve to the outer sleeve, and
wherein a tip of the shaft is provided with a cone supported in a bearing cap.

2. The torque limiter as claimed in claim 1, wherein the snap sleeve is fixed to rotate with the outer sleeve by a drive element provided on the inner wall of the outer sleeve, said drive element protruding radially inwardly and engaging in a slot in the snap sleeve.

3. The torque limiter as claimed in claim 1, wherein the rolling elements are pins and the rolling element receiving areas are slots.

4. The torque limiter as claimed in claim 1, wherein the snap sleeve (3) is made of a polyetheretherketone (PEEK).
